(19) United States
(12) Patent Application Publication
(10) Pub. No.: US 2008/0035711 A1
(43) Pub. Date: Feb. 14, 2008

(54) Cooling Apparatus Comprising Metal Tubes Connected Through Soldered Lap Joints

(76) Inventor: Colin Genner, Durham (GB)

Correspondence Address: PEPPER HAMILTON LLP, ONE MELLON CENTER, 50TH FLOOR, 500 GRANT STREET, PITTSBURGH, PA, 15219, US

(21) Appl. No.: 10/598,403

(22) PCT Filed: Feb. 25, 2005
(86) PCT No.: PCT/GB05/00730

§ 371 Date: Jul. 2, 2007

(30) Foreign Application Priority Data
Feb. 27, 2004 (GB) 0404275.0

(51) Int. Cl. B23K 1/00; B23K 35/26; F25D 11/00

(52) U.S. Cl. 228/262.9; 62/440

(57) ABSTRACT

A cooling apparatus, e.g. a refrigerator or a freezer, comprises an insulated chiller or freezer box, accessible by a door, and means for cooling the interior of the box, said means comprising a heat exchanger including a tube evaporator system, wherein a first part of the system is located inside of the box and a second part of which is located outside of the box, wherein said system comprises a plurality of tubes connected to provide a pathway for a refrigerant which in use is circulated between said first part and said second part of said system. The metal tubes of the system which in use contact refrigerant which is at a temperature of 0° C. or less are connected by lap joints sealed in a gas tight manner by a solder which a) has a melting temperature of from 180 to 300° C. and/or b) is a tin solder.

This invention is concerned with cooling apparatus and method of their manufacture. More particularly, this invention is specifically concerned with cooling apparatus selected from refrigerators and freezers comprising tube evaporator systems which under operating conditions circulate refrigerants at below freezing temperatures.

Domestic refrigerators and freezers are generally of a similar design, each including an insulated chiller or freezer box, accessible by a door, and means for cooling the interior of the box. Conventionally, the means for cooling the interior of the box is a heat exchanger including a tube evaporator system, wherein a first part of the system is located inside of the box and a second part of which is located outside of the box.

Under normal operating conditions, refrigerant is circulated through the first part of the system at temperatures of less than 0° C., typically −5 to −50° C. If the system is being used in a refrigerator, the circulating temperature of the refrigerant in the first part of the system is usually −5 to −15° C., whereas if the system is being used in a freezer, the circulating temperature of the refrigerant in the first part of the system is usually −15 to −50° C.

At least the first part of the tube evaporator system, i.e. the part of the system which in use is exposed to sub-zero temperatures, has historically been manufactured from steel or copper tubes connected by lap joints employing a high temperature brazing flux and solder to seal the joint. The joining procedure which is the current standard practiced for high temperature brazing, is typically set out in British Standard 1723, Part 2, 1986, or its foreign equivalent standards

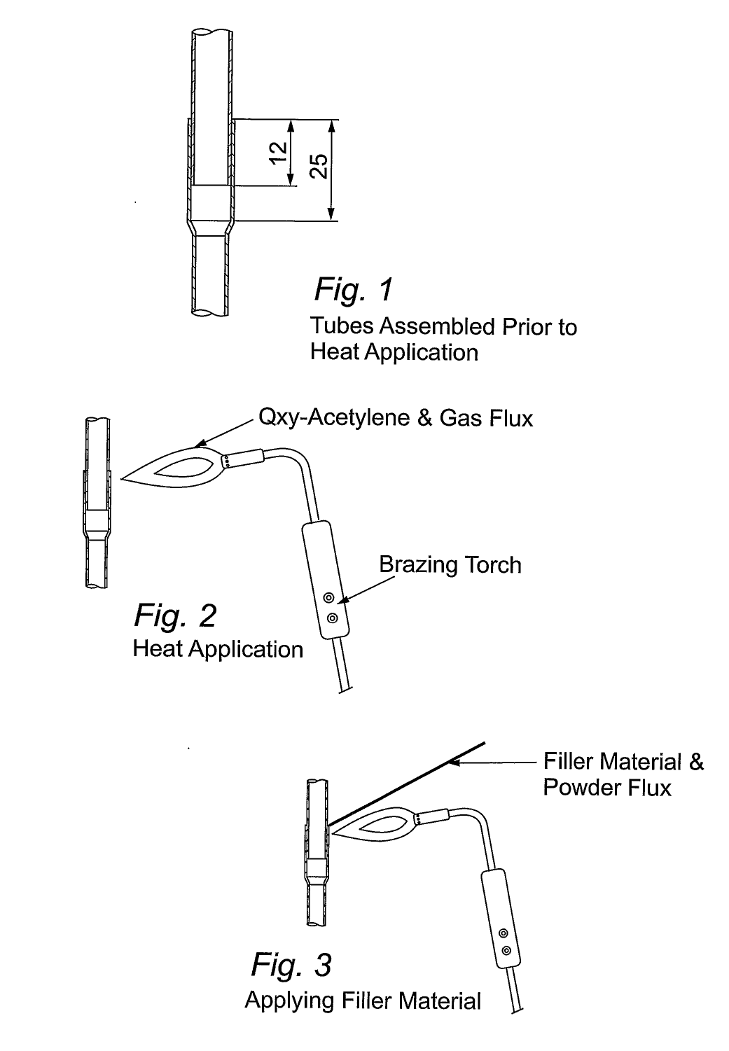

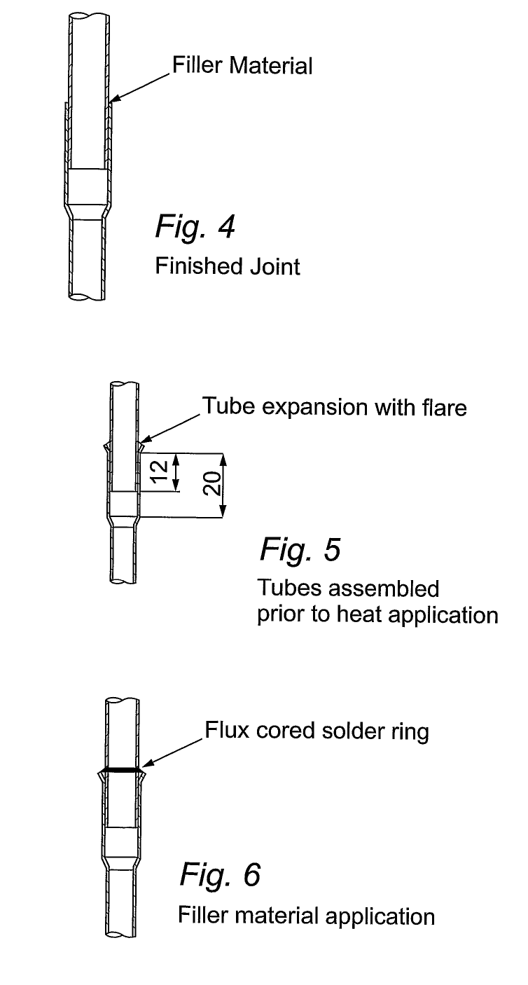

The joining procedure, typically set out in British Standard 1723, Part 2, 1986, is intended to produce a gas tight metallic seal between two similar metal tubes (steel-to-steel or copper-to-copper) or dissimilar metal tubes (steel-to-copper) by introducing a molten filler material into the joint area, which subsequently sets hard. In summary, the end of one of the tubes enters the other for a distance of between 5 and 20 mm by one end being expanded to form a lap joint (e.g. FIG. 1). The clearance between the tube interfaces is adapted to allow maximum penetration of the filler material during subsequent brazing or soldering operations. In accordance with the Standard, the filler material is a high-temperature brazing metal or solder, which requires temperatures in excess of 350° C., typically greater than 450° C. to effect the seal. Whilst the high temperature required to effect the seal is usually provided by the flame brazing method, whereby a flame is supplied from a brazing torch with e.g. an oxygen and acetylene source (e.g. FIG. 2), other methods such as induction or resistance brazing may also be used. The filler material is manually applied using e.g. a solder rod to the join of the two heated tubes and melts at an appropriate temperature in a way that allows the filler material to run freely around the circumference of the tubes allowing capillary action to pull the filler metal into the joint interface between the tubes (e.g. FIG. 3). This completes the process as cooling allows the molten filler to form a leak tight seal around the joint of the tubes (e.g. FIG. 4).

The use of high temperature brazing metals or solders for joining the tubes means that a high amount of energy is consumed in the process. Further, because of the labour intensive manual nature of the process and the fact that a long heating time is required to get the tubes to the high processing temperature, the process is also time consuming.

Low temperature solders, such as tin alloys, are well known and have been used for many years in forming lap joints between tubes in e.g. tube evaporating systems employed in air conditioning systems, wherein the coolant is circulated in the system at temperatures above 0° C. Such low temperature solders typically comprise tin, to either a greater or lesser extent. Tube evaporator system manufacturers have been prejudiced against using tin alloy solders in systems intended for use in refrigerators and freezers, where the operating temperature of the seal can be well below 0° C., as it being perceived that such “soft” solders would be too weak to provide the tensile strength of the joint required in such low temperature applications. The existence of this prejudice is perhaps evidenced by the fact that such systems are presently manufactured typically to British Standard 1723, Part 2, 1986 or its foreign equivalent standards.

It is an object of the present invention to provide cooling apparatus which can be manufactured in a more energy and time efficient manner.

In accordance with the present invention, there is provided a cooling apparatus comprising an insulated chiller or freezer box, accessible by a door, and means for cooling the interior of the box, said means comprising a heat exchanger including a tube evaporator system, wherein a first part of the system is located inside of the box and a second part of which is located outside of the box, wherein said system comprises a plurality of tubes connected to provide a pathway for a refrigerant which in use is circulated between said first part and said second part of said system; characterised in that:

the metal tubes of the system which in use contact refrigerant which is at a temperature of −5 to −50° C. are connected by lap joints sealed in a gas tight manner by a solder which has a melting temperature of from 180 to 300° C., preferably from 200 to 260° C., more preferably from 220 to 250° C.

It is believed that any solder which has a melting temperature in the relevant range and which is compatible with the metal tubes will be suitable for use in the present invention. A person skilled in the art will readily know what types of solders are compatible for use with tubes of a given metal or metals. When the tubes are copper or steel, the solder is preferably a tin alloy solder, preferably a tin alloy solder comprising at least 80% by wt Sn, more preferably at least 95% by wt Sn. In one embodiment, the solder may comprise at least 99 wt % Sn, for example the solder may comprise 99% Sn and 1% Cu.

In another aspect, there is provided a method for manufacturing cooling apparatus comprising an insulated chiller or freezer box, accessible by a door, and means for cooling the interior of the box, said means comprising a heat exchanger including a tube evaporator system, wherein a first part of the system is located inside of the box and a second part of which is located outside of the box, wherein said system comprises a plurality of tubes connected to provide a pathway for a refrigerant which in use is circulated between said first part and said second part of said system; the method being characterised in that:

the metal tubes of the system which in use contact refrigerant which is at a temperature of −5 to −50° C. are joined by a process comprising:

preparing a lap joint between two of said tubes and sealing said tubes in a gas tight manner with a solder having a melting temperature of from 180 to 300° C., preferably from 200 to 260° C., more preferably from 220 to 250° C. Preferably, the solder is a tin alloy solder, preferably a tin alloy solder comprising at least 80% by wt Sn, more preferably at least 95% by wt Sn. In one embodiment, the solder may comprise at least 99 wt % Sn, for example the solder may comprise 99% Sn and 1% Cu.

One of the metal tubes used to form the lap joint preferably comprises steel or copper and the other metal tube also preferably comprises steel or copper. More preferably, both of said tubes comprise the same metal.

Because a low temperature solder is used in the present invention, manufacturers can make significant labour and energy savings.

The cooling apparatus of the present invention is a refrigerator or other apparatus which in use maintains the temperature within the insulated box at about 0° C. or a few degrees above 0° C., such as a drinks chiller, or it may be a freezer or other apparatus which in use maintains the temperature within the insulated box below 0° C.

In one particular embodiment of the method of the present invention, the female tube of the tubes forming the lap joint is presented with a flare for receiving solder (e.g. FIG. 5).

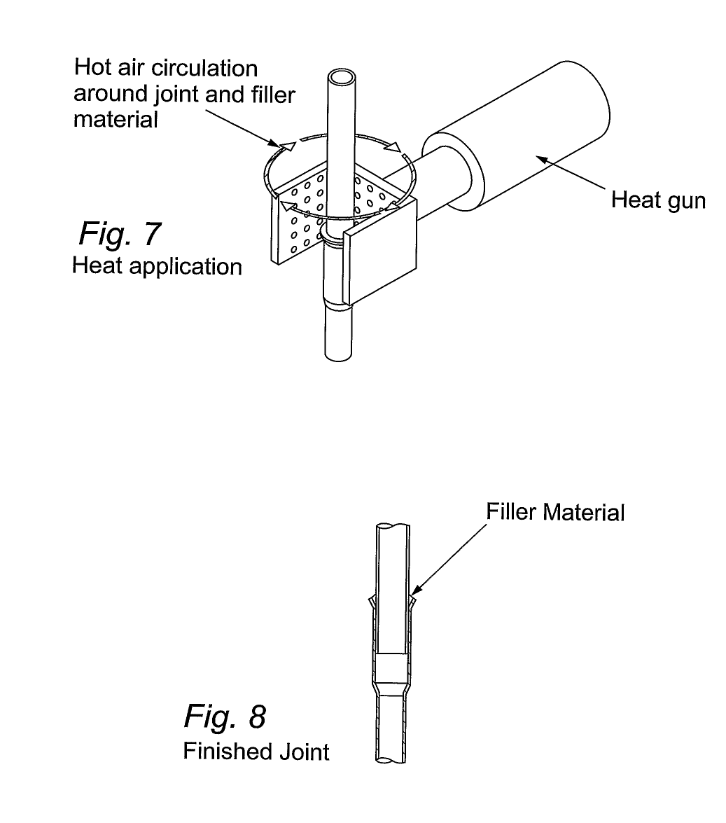

Preferably, the solder is presented in the form of a solder ring, which is seated manually at the joint site around the male tube of the tubes forming the lap joint and then heated and melted, whereby the solder fills the interstices between the tubes (e.g. FIG. 6). Preferably, the solder is heated and melted by heat from a heat gun, which is capable of providing hot air circulation around the joint (e.g. FIG. 7). When cooled, the solder solidifies and forms an air-tight seal between the tubes, so forming the finished joint (e.g. FIG. 8). These embodiments enable significant time savings in the manufacture of the systems.

In one embodiment of the present invention, all the joints of the tubes used in the manufacture of tube evaporator system are prepared using the low temperature solder.

1. A cooling apparatus comprising an insulated chiller or freezer box, accessible by a door, and means for cooling the interior of the box, said means comprising a heat exchanger including a tube evaporator system, wherein a first part of the system is located inside of the box and a second part of which is located outside of the box, wherein said system comprises a plurality of tubes connected to provide a pathway for a refrigerant which in use is circulated between said first part and said second part of said system;
characterised in that:
the metal tubes of the system which in use contact refrigerant which is at a temperature of −5 to −50° C. are connected by lap joints sealed in a gas tight manner by a solder which has a meltings temperature of from 180 to 300° C.

2. A method for manufacturing cooling apparatus comprising an insulated chiller or freezer box, accessible by a door, and means for cooling the interior of the box, said means comprising a heat exchanger including a tube evaporator system, wherein a first part of the system is located inside of the box and a second part of which is located outside of the box, wherein said system comprises a plurality of tubes connected to provide a pathway for a refrigerant which in use is circulated between said first part and said second part of said system; the method being characterised in that:
the metal tubes of the system which in use contact refrigerant which is at a temperature of −5 to −50° C. are joined by a process comprising:
preparing a lap Joint between two of said tubes and sealing said tubes in a gas tight manner with a solder which has a melting temperature of from 180 to 300° C.

3. A cooling apparatus as claimed in claim 1, wherein the solder comprises at least 80% by wt tin.

4. A cooling apparatus as claimed in claim 1, wherein the solder comprises at least 95% by wt tin.

5. A cooling apparatus as claimed in claim 1, wherein the solder melts in the range of from 200 to 250° C.

6. A cooling apparatus as claimed in claim 1, wherein the solder melts in the range of 220 to 240° C.

7. A cooling apparatus as claimed in claim 1, wherein the solder comprises at least 80% by wt tin and melts in the range 200 to 250° C.

8. A method as claimed in claim 2, wherein the solder comprises at least 80% by wt tin.

9. A method as claimed in claim 2, wherein the solder comprises at least 95% by wt tin.

10. A method as claimed in claim 2, wherein the solder melts in the range of from 200 to 250° C.

11. A method as claimed in claim 2, wherein the solder melts in the range of 220 to 240° C.

12. A method as claimed in claim 2, wherein the solder comprises at least 80% by wt tin and melts in the range 200 to 250° C.
